(19) United States
(12) Patent Application Publication
(10) Pub. No.: US 2010/0137534 A1
(43) Pub. Date: Jun. 3, 2010

(54) METHOD FOR PREPARING MICROGEL PARTICLES BY CONTROLLED RADICAL POLYMERIZATION IN AN AQUEOUS DISPERSION USING NITROXIDE CONTROL AGENTS

(75) Inventors: Stephanie Magnet, Morlanne (FR); Bemadette Charleux, Vincennes (FR); Guillaume Delaittre, Paris (FR); Maud Save, Issy Les Moulineaux (FR)

Correspondence Address: ARKEMA INC.;PATENT DEPARTMENT - 26TH FLOOR, 2000 MARKET STREET, PHILADELPHIA, PA, 19103-3222, US

(73) Assignees: Arkema France, Colombes (FR); Centre National De La Recerche Scientifique (CNRS), Paris (FR); University of Paris VI, Paris (FR)

(21) Appl. No.: 12/524,975

(22) PCT Filed: Jan. 28, 2008
(86) PCT No.: PCT/EP08/50975

§ 371 Date: Feb. 2, 2010

(30) Foreign Application Priority Data
Jan. 29, 2007 (FR) 0752941

(51) Int. Cl. C08F 4/00

(52) U.S. Cl. 526/193

(57) ABSTRACT

The invention relates to a method for preparing microgel particles according to a method of controlled radical polymerization in an aqueous dispersion using particular control agents of the nitroxide type. Use in the biomedical field, and in the field of agrochemistry, cosmetics, surface coatings.

### TECHNICAL FIELD

The present invention relates to a process for preparing microgel particles according to a process of controlled radical polymerization in an aqueous dispersion using control agents, in particular control agents of the nitroxide type.

The microgel particles obtained via this process may be used as encapsulating material, for example for medicaments, insecticides, herbicides, fillers or pigments.

They may also be used as additives for modifying the viscosity of certain liquid media.

Thus, the microgel particles obtained via this process are of value most particularly in the field of pharmacy, biomedicals, agrochemistry, human or animal nutrition, cosmetics, and surface coatings such as paints.

### PRIOR ART

Processes for preparing microgel particles have already been studied in the prior art.

Microgel particles are conventionally prepared as an aqueous dispersion via a conventional radical polymerization process (i.e. nonliving polymerization) using vinyl monomers optionally in the presence of one or more crosslinking comonomers.

An aqueous-dispersion polymerization is characterized by the fact that at the start of polymerization, the reaction medium is a homogeneous solution (the monomers being soluble), whereas at the end of polymerization, the reaction medium is in the form of a latex, i.e. an assembly of polymer particles stabilized in the reaction medium.

Three protocols of conventional radical polymerization in aqueous dispersion have mainly been used in the prior art for the preparation of microgel particles:
a first protocol using the presence of surfactant additives (such as sodium lauryl sulfate). The role of the surfactant additive is to ensure colloidal stability of the latex. The sizes of the microgel particles obtained are of the order of or are less than about a hundred nanometers. However, at the end of polymerization, a step of removal of the surfactant must be envisioned;
a second protocol using a charged radical polymerization initiator, in the absence of surfactant additives. The colloidal stability of the latex is then ensured by the presence of charged fragments of the initiator that are located at chain ends. However, in order to ensure good stability of the final latex, the solids content of the emulsion should remain very low and generally less than 5% by weight;
a third protocol involving an ionic, ionizable or uncharged water-soluble comonomer, and not requiring the use of surfactant additives. In this case, the thermal behavior of the latex is very sensitive to the composition of the system.

Other authors have developed processes for preparing microgel particles by means of a controlled radical polymerization. Thus, WO 2001/077198 describes a process for preparing crosslinked micelles forming micro gel particles, involving a controlled radical polymerization of the RAFT type (reversible addition-fragmentation chain transfer) comprising the following steps:
a step of RAFT polymerization, in the presence of a chain-transfer agent of the RAFT type, of one or more solvophobic monomers and of one or more solvophilic monomers to form a block copolymer comprising one or more solvophobic blocks and one or more solvophilic blocks, the solvophobic block(s) being insoluble in a dispersion medium and the solvophilic block(s) being soluble in a dispersion medium;
a step of dispersing said block copolymer in said dispersion medium to form micelles; and
step of stabilizing the micelles to form said microgel.

The stabilization step may be performed by crosslinking one or more functions present on the blocks of the block copolymer.

This process has the following drawbacks:
it is performed in a medium comprising an organic solvent, which may require post-treatment steps in order to be able to use these particles in fields of application that prohibit organic solvents;
it requires a large number of different implementation steps and manipulations that are not always easy;
in the case of RAFT polymerization, the use of a conventional primer may cause the formation of homopolymers, since the conditions for obtaining block copolymers are not easy to determine.

There is thus a real need for a process for preparing microgel particles, which can be used in aqueous medium, in the absence of surfactant additives, and which allows the production of stable, concentrated dispersions of microgel particles of controlled morphology, the particle sizes of which may be less than or equal to 100 nanometers, and which is simple to perform.

### DESCRIPTION OF THE INVENTION

Thus, the invention relates to a process for preparing microgel particles in aqueous medium, comprising the following steps:
a) a step of preparing a living macroinitiator obtained by polymerization of one or more monomers in the presence of a control agent corresponding to one of the following formulae:

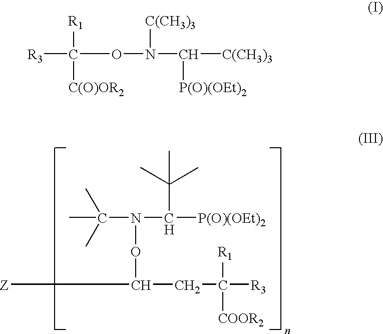

in which:
   R₁ and R₃, which may be identical or different, represent a linear or branched alkyl group having a number of carbon atoms ranging from 1 to 3;
   R₂ represents a hydrogen atom, a linear or branched alkyl group having a number of carbon atoms ranging from 1 to 8, a phenyl group, an alkali metal such as Li, Na or K, or an ammonium ion such as NH₄⁺ or NHBu₃⁺; preferably, R₁ and R₃ are CH₃ and R₂ is H;
   Z represents an aryl group or a group of formula Z₁—[X—C(O)]ₙ, in which Z₁ represents a polyfunctional structure originating, for example, from a compound of the polyol type, X is an oxygen atom, a nitrogen atom bearing a carbon-based group or a hydrogen atom, or a sulfur atom; and
   n is an integer greater than or equal to 2;
b) a step of adding to the reaction medium obtained after step a) at least one vinyl monomer, this monomer being different than that of step a);
c) a step of adding to the reaction medium at least one crosslinking comonomer, the crosslinking comonomer being different than the monomers of steps a) and b), this addition step c) being performed simultaneously or consecutively relative to the addition step b),
in which the constituent monomer(s) of the living macroinitiator of step a) and/or the vinyl monomers of step b) and/or the crosslinking comonomer(s) of step c) comprise at least one function chosen from —CO₂H, —SO₃H, ammonium, ethylene oxide, amino and amide, said function possibly existing in the form of salts.

The term “amino group” generally means a group —NH₂ that is optionally N-substituted, for example with one or more alkyl groups.

The term “amide group” generally means a group —CO—NH₂ that is optionally N-substituted, for example with one or more alkyl groups.

The term “ammonium group” generally means a group —NH₃⁺ that is optionally N-substituted, for example with one or more alkyl groups.

It is pointed out that the abbreviation Et corresponds to the ethyl group and that the abbreviation Bu corresponds to the butyl group, which may exist in different isomeric forms (n-butyl, sec-butyl or tert-butyl).

The process of the invention differs essentially from the processes of the prior art by the use of a control agent of the nitroxide type as defined above, which allows the formation of a living macroinitiator, from which a polymerization reaction may be re-engaged with vinyl monomers and one or more crosslinking comonomers, the choice of these monomers and comonomers being made so as to generate microgel particles that have the desired properties.

One of the important characteristics of this process is that the monomers included in the constitution of the microgel particles (monomers of the living macroinitiator and/or vinyl monomers and/or crosslinking comonomers) comprise at least one —CO₂H, —SO₃H, ammonium, ethylene oxide, amino or amide function. These functions fulfill the role in aqueous medium of stabilizer. It is thus possible to dispense with the addition to the reaction medium of surfactant additives, as was the case in the prior art, and consequently to dispense with the steps for removing these surfactant additives at the end of the process. The particles thus obtained have stability inherent in the monomers of which they are constituted.

By modifying especially the content of crosslinking comonomer, the process of the invention also makes it possible to control the size and morphology of the particles obtained. It is thus possible to obtain particles less than or equal to 100 nm in size.

The process of the invention is conventionally performed in a single reaction medium and does not require, as is the case for certain processes of the prior art, dispersion in a suitable dispersion medium of presynthesized particles.

Due to the fact that the process of the invention is performed in aqueous medium, the particles obtained at the end of the process may be used in their native form, i.e. without requiring any post-treatment steps.

What is more, compared with a polymerization of the RAFT type, the presence of homopolymers is limited, since only the first block (i.e. the living macroinitiator) creates radicals and thus initiates the polymerization.

According to the invention, it is pointed out that the term “microgel particles” generally means polymer particles suspended in the aqueous medium, having a size of less than or equal to 100 nm and preferably ranging from 40 to 300 nm.

It is pointed out that, for the purposes of the invention, the term “living macroinitiator” means a polymer comprising at least one end that can be re-engaged in a polymerization reaction by addition of monomers to the reaction medium. The term “living macroinitiator” also corresponds to the term “living polymer”.

It is pointed out that the term “vinyl monomer” means monomers comprising an ethylenic function capable of reacting in a polymerization reaction.

Preferably, the constituent monomers of the living macroinitiator of step a) comprise at least one function chosen from —CO₂H, —SO₃H, ammonium, ethylene oxide, amino and amide, said function possibly existing in the form of salts.

Constituent monomers of the living macroinitiator of step a) may be chosen from (meth)acrylic monomers, dialkylaminoalkyl (meth)acrylate monomers, trialkyl-ammoniumalkyl (meth)acrylate halides, (alkoxy)polyalkylene glycol (meth)acrylate monomers, (meth)acrylamide monomers, for instance (di)alkyl(meth)acrylamides, optionally comprising a sulfonate group (such as acrylamidomethylpropanesulfonate), and styrene monomers comprising a sulfonate group (such as styrene sulfonate).

In the family of unsaturated carboxylic monomers, mention may be made advantageously of acrylic acid or methacrylic acid.

As an example of a control agent that may be used, mention may be made of the agent corresponding to the following formula:

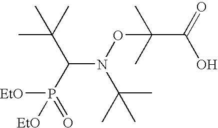

The control agents of formula (III) are generally derived from a process that consists in reacting one or more alkoxyamines of formula (I) below:

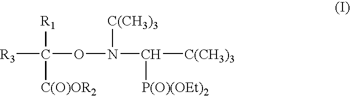

in which R₁, R₂ and R₃ are as defined previously,
with at least one polyunsaturated compound of formula (II):

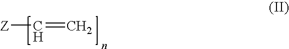

in which Z represents an aryl group or a group of formula Z₁—[X—C(O)]ₙ, in which Z₁ represents a polyfunctional structure originating, for example, from a compound of the polyol type, X is an oxygen atom, a nitrogen atom bearing a carbon-based group or a hydrogen atom, or a sulfur atom, and n is an integer greater than or equal to 2, in the presence or absence of solvent(s), preferably chosen from alcohols, for instance ethanol, aromatic solvents, fluorinated solvents, ethers and polar aprotic solvents, at a temperature generally ranging from 0 to 90° C. and preferably from 25 to 80° C., the mole ratio between the monofunctional alkoxyamine(s) of formula (I) and the polyunsaturated compound(s) of formula (II) being from 1.5 to 1.5 n and preferably from n to 1.25 n, n being as defined above.

As examples of polyunsaturated compounds that may be used to prepare polyfunctional alkoxyamines as defined above, mention may be made of polyfunctional vinylbenzenes (Z then being an aryl group) or polyfunctional acrylic derivatives (Z then being a group of formula Z₁—[X—C(O)]ₙ). Preferably, the polyunsaturated compound is divinylbenzene, trivinylbenzene, ethylene glycol diacrylate, 1,3-butanediol diacrylate, 1,4-butanediol diacrylate, 1,6-hexanediol diacrylate, neopentyl glycol diacrylate, cyclohexanedimethanol diacrylate, diethylene glycol diacrylate, triethylerie glycol diacrylate, tetraethylene glycol diacrylate, dipropylene glycol diacrylate, tripropylene glycol diacrylate, polyethylene glycol diacrylates (sold by Sartomer under the names SR259, SR344 and SR610), alkoxylated hexanediol diacrylates (sold by Sartomer under the names CD561, CD564 and CD560), bisphenol-A diacrylate, ethoxylated bisphenol-A diacrylates (sold by Sartomer under the names SR349, SR601, SR602 and CD9038), trimethylolpropane triacrylate, pentaerythrityl triacrylate, tris(2-hydroxyethyl) isocyanurate triacrylate, ethoxylated trimethylolpropane triacrylates (sold by Sartomer under the names SR454, SR499, SR502, SR9035 and SR415), propoxylated glyceryl triacrylate (sold by Sartomer under the name SR9020), propoxylated trimethylolpropane triacrylate (sold by Sartomer under the names SR492 and CD501), pentaerythrityl tetraacrylate, bis(trimethylolpropane) tetraacrylate, ethoxylated pentaerythrityl tetraacrylate (sold by Sartomer under the name SR494), dipentaerythrityl pentaacrylate, dipentaerythrityl hexaacrylate-modified caprolactones (sold by Sartomer under the names Kayarad DCPA20 and DCPA60), and dipentaerythrityl polyacrylate (sold by UCB Chemicals under the name DPHPA).

When Z corresponds to the formula Z₁—[X—C(O)]ₙ, the control agents correspond to formula (IIIa) below:

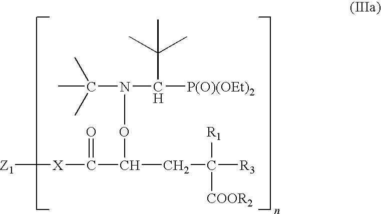

Z₁ generally corresponding to an alkylene group.

One particular example of a control agent in accordance with the general definition given above is the polyfunctional alkoxyamine corresponding to the following formula:

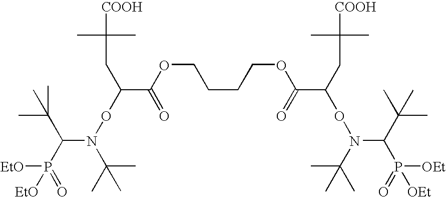

this polyfunctional alkoxyamine being derived from the reaction of a monofunctional alkoxyamine of formula (I) with 1,4-butanediol diacrylate.

The control agents of formula (I) and/or the control agents of formula (III) also play a role as initiator and as emulsifier; thus, the surfactant properties of the control agents of formula (I) and/or control agents of formula (III) make it possible to avoid the use of surfactant additives.

What is more, some of the monomers included in the constitution of the particles comprising —CO₂H, —SO₃H, ammonium, ethylene oxide, amino or amide functions also contribute toward stabilizing said particles without the need to use surfactants.

After step a), a living macroinitiator is thus obtained, comprising an end having the following formula:

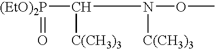

this end being denoted by the abbreviation SG1.

This macroinitiator comprising such a reactive end may be re-engaged in a polymerization reaction, by means of the use of monomers, which is the case of the invention in steps b) and c).

The vinyl monomers introduced in step b) may be chosen from vinylaromatic monomers such as styrene or substituted styrenes, acrylic monomers such as alkyl or aryl acrylates, functional acrylates, methacrylic monomers such as alkyl or aryl methacrylates, functional methacrylates and monomers of the acrylamide and methacrylamide families.

Preferably, the vinyl monomers introduced in step b) are monomers of the acrylamide and methacrylamide families.

Preferably, the acrylamide monomers are monoalkylacrylamides or dialkylaerylamides.

As examples of dialkylacrylamide monomers that may be used, mention may be made of N,N-dimethylacrylamide, N,N-diethylacrylamide or N,N-diisopropylacrylamide.

As examples of monoalkylacrylamide monomers that may be used, mention may be made of N-methylacrylamide, N-ethylacrylamide or N-isopropylacrylamide.

These vinyl monomers are advantageously introduced into the reaction medium in a proportion of at least 10% by weight and preferably greater than 20% by weight relative to the total weight of the reaction medium.

The particular feature of the polymers bearing acrylamide units is that they have a lower critical solution temperature (LCST) in water (at about 32° C. for the units derived from N-isopropylacrylamide). Above this temperature, the polymer is soluble in the reaction medium, whereas it precipitates for temperatures above the LCST. These changes in physical state of the polymer as a function of the temperature give the microgel particles encapsulation properties. Specifically, when the polymer is heated to temperatures above the LCST and in the presence of an active principle, this active principle is encapsulated in the particle, and is then released at low temperature (more specifically at a temperature below the LCST).

The drawback of polymers with an LCST is that the particles dissolve according to the temperature conditions under which the polymers are placed. The invention comprising a step of adding a crosslinking comonomer allows the particles to conserve their integrity even at temperatures below the LCST and to avoid the dissolution of the polymer in the reaction medium.

According to the invention, the process includes a step c) that consists in adding a crosslinking comonomer.

The term “crosslinking comonomer” means a monomer which, by virtue of its reactivity with the other monomers present in the polymerization medium, is capable of generating an interwoven three-dimensional network. From a chemical viewpoint, a crosslinking comonomer generally comprises at least two ethylenic polymerizable functions, which, on reacting, are liable to create bridges between several polymer chains.

These crosslinking comonomers may be liable to react with the unsaturated monomers of step b).

Among the crosslinking comonomers that may be mentioned are divinylbenzenes, trivinylbenzenes, allyl(meth)acrylates, diallyl maleate polyol(meth)acrylates such as trimethylolpropane tri(meth)acrylates, alkylene glycol di(meth)acrylates containing from 2 to 10 carbon atoms in the carbon chain, such as ethylene glycol di(meth)acrylates, 1,4-butanediol di(meth)acrylates, 1,6-hexanediol di(meth)acrylates, and N,N′-alkylenebisacrylamides, such as N,N′-methylenebisacrylamide. N,N′-Methylenebisaerylunide will preferably be used as crosslinking agent.

The crosslinking comonomers may also be compounds that are capable of reacting with the polymerization products. Mention may be made of diglycidyl ethers, such as ethylene glycol diglycidyl ether.

The crosslinking comonomer is advantageously introduced into the reaction medium in a content ranging from 1% to 12% by weight of vinyl monomer(s) introduced in step b) or from 0.2% to 2% by weight relative to the total weight of the reaction medium.

The addition step c) may be performed simultaneously or consecutively relative to the addition step b).

Thus, according to a first embodiment, the crosslinking comonomer may be added at the same time as the vinyl monomer(s). This embodiment is particularly suitable when the crosslinking comonomer is introduced in an amount of less than 10% by weight and more particularly less than 5% by weight relative to that of the vinyl monomer(s). The controlled nature of the radical polymerization enables moderation of the chain growth and thus avoids the creation of crosslinking nodes in solution before the micellization.

According to a second embodiment, the crosslinking comonomer may be added consecutively to the vinyl monomer(s). Preferably, the crosslinking comonomer is added after the step of forming the polymer particles (“nucleation step”). This embodiment is particularly suitable when the crosslinking comonomer is introduced in an amount of greater than 5% by weight and more particularly greater than 10% by weight relative to that of the vinyl monomer(s). By thus delaying the addition of crosslinking comonomer, the formation of microgel in the reaction medium is overcome. It is then possible to increase the dose of the crosslinking comonomer and thus to adjust the level of crosslinking of the particle at its core. This embodiment is particularly advantageous in the sense that it allows the nucleation step to be dissociated from the crosslinking step, in order to obtain better control of the sizes of the particles generated during the process. As a result of their living nature, all the polymer chains are incorporated into the microgel.

Whether it is for the embodiments described above or for other embodiments, the process of the invention is generally performed at temperatures generally above 80° C. and preferably above 100° C.

The process of the invention is performed in aqueous medium and, advantageously, in the absence of surfactant additives. Specifically, one of the particular features of the invention is that the colloidal stability of the microgel particles obtained is not ensured by the addition of surfactant additives to the reaction medium, but rather is ensured by the presence of polymers comprising surfactant functions, in particular —CO₂H functions.

The concentration of active materials, i.e. residual monomers and polymers, in the polymerization medium is advantageously greater than 10% by weight and preferably greater than 20% by weight.

When the microgel particles prepared according to the process of the invention are intended for making encapsulation materials, it may be envisioned to include in the process a step of adding to the reaction medium components intended to be encapsulated. This addition step may be simultaneous with step b) or, if step c) is consecutive to step b), this addition step may proceed simultaneously with or after step c).

The components intended to be encapsulated may be organic molecules, such as medicaments, insecticides, herbicides, colorants, inorganic molecules such as inorganic pigments, catalysts or mineral fillers.

Finally, the process of the invention may include, if need be, a step of isolating the microgel particles from the aqueous medium, this isolation step possibly being performed, for example, by filtration.

A subject of the invention is also microgel particles that may be obtained via the process as defined above.

The microgel particles obtained according to the process of the invention have a core that is more or less crosslinked, depending on the content of crosslinking comonomer used, and a hairy crown, which gives them good stability in the form of colloids, irrespective of the temperature, the hydrophilicity or the hydrophobicity of the core. The nature of the monomers used that constitute the core of the particle may be modified as a function of the property that it is desired to give the microgel particle. For example, if it is desired to obtain heat-sensitive microgel particles, monomers of the dialkylacrylamide type will be chosen for use. Taking the monomer N,N-diethylacrylamide as an example, the following phenomenon will be observed: at high temperature (i.e. at a temperature above the LCST), the block copolymer chains assemble and hydrophobic microgel particles are formed. When the temperature of the reaction medium is below the LCST, the particles become swollen with water but do not dissociate on account of the existence of chemical crosslinking nodes, and the viscosity of the medium increases greatly.

As a result of their intrinsic properties, the microgel particles of the invention obtained according to the process of the invention may find applications in varied fields of use.

The microgel particles may especially be used for encapsulating components such as organic molecules, such as medicaments, insecticides, herbicides, colorants, inorganic molecules such as inorganic pigments, catalysts or mineral fillers. When the particles are based on units with an LCST, release of the components is then possible, when the temperature decreases and passes below the LCST of the component polymer of the microgel particle. They thus find an application most particularly in the field of pharmacy, agrochemistry, human or animal nutrition, biomedicals, cosmetics and paints.

These particles may also be used as thickeners, in order to modify the viscosity of a liquid medium, especially in the field of surface coatings.

In the field of cosmetics, they may be used in products of the lipstick, concealer or foundation type. These particles may also be the basis for formulations of the oil-in-gelled phase type or, conversely, of the aqueous phase (gelled or not gelled)-in-oil-in-gelled phase type.

The invention will now be described with the aid of the examples that follow, which are given as nonlimiting illustrations.

### BRIEF DESCRIPTION OF THE DRAWINGS

FIGS. 1 and 2 represent, respectively, the monitoring of the conversion of the monomers into polymer as a function of time and the change in size of the microgel particles in the course of temperature cycles in Example 1.

FIGS. 3 and 4 represent, respectively, the monitoring of the conversion of monomers into polymer as a function of time and the change in size of the microgel particles in the course of temperature cycles in Example 2.

FIGS. 5 and 6 represent, respectively, the monitoring of the conversion of monomers into polymer as a function of time and the change in size of the microgel particles in the course of temperature cycles in Example 3.

### DETAILED DESCRIPTION OF PARTICULAR EMBODIMENTS

### Example 1

This example describes the copolymerization in aqueous dispersion of N,N-diethylacrylamide with N,N′-methylenebisacrylamide, the N,N′-methylenebisacrylamide being introduced into the reaction medium at the same time as the N,N-diethylacrylamide in a proportion of 3 mol % of N,N′-methylenebisacrylamide.

1.61 g of poly(acrylie acid)-SG1 macroinitiator of molar mass 1880 g.mol⁻¹ and 0.45 g of Na₂CO₃ are dissolved in a beaker in 18.52 g of 1M NaOH and 104.19 g of deionized water. In another beaker, 30.01 g of N,N-diethylacrylamide are mixed with 1.09 g of N,N′-methylenebisacrylamide and 0.0297 g of SG1. The two solutions are then pooled and degassed by sparging with nitrogen, and stirred at 300 rpm for 20 minutes.

The mixture is then introduced into a 300 mL tank preheated to 110° C., and then stirred at 300 rpm under a pressure of 3 bar.

The temperature of the reaction medium is maintained at 112° C. A sample of about 5 mL is taken every 30 minutes and then every hour for 8 hours, and the reaction is stopped after 24 hours.

The size of the particles is determined before each sample has cooled, by adding a few tens of μL of the sample to 6 mL of deionized water at a temperature above 70° C. in a parallelepipedal polystyrene tank. The dilute sample is then analyzed by dynamic light scattering on a Malvern Nano ZS90 machine. The dilute sample is then characterized when cool, by lowering the nominal temperature of the Nano ZS90 machine to 15° C., and 50° C.-15° C.-50° C. temperature cycles are then performed.

The degree of conversion of the monomers into polymer is determined by gravimetry. About 1 g of each sample is placed in an aluminum crucible and then evaporated in a fume cupboard overnight, and then for a few hours in a desiccator heated at 85° C. under reduced pressure.

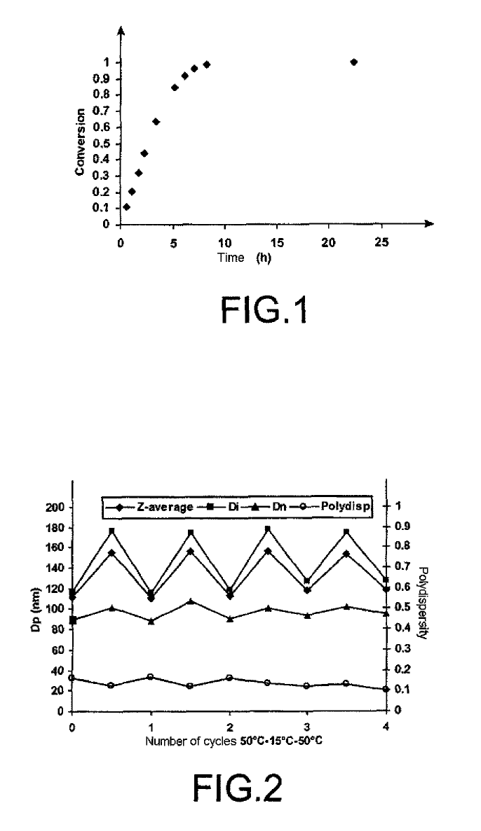

The two graphs given in FIGS. 1 and 2 show, respectively, the monitoring of the conversion of the monomers into polymer and the change in size of the microgel particles in the course of the temperature cycles.

It is seen in FIG. 1 that the monomers are almost entirely consumed as polymer after a reaction time of just under ten hours. The latex is recovered while hot after virtually 24 hours and analyzed before cooling below the LCST by dynamic light scattering. The change in the size of the particles as a function of the measurement temperature (15° C. or 50° C.) can be followed in FIG. 2. Z-average is the average calculated directly by the Nano ZS90 dynamic light scattering machine. This machine also gives intensity averages (Dₗ), number averages (Dₙ) and also a polydispersity index. A sample is considered as being monodisperse for values of this index of less than or equal to 0.1. It is seen in this figure that the diameter of the particles formed in the reactor (cycle 0) is about 110 nm (Z-average). The latex then cooled to 15° C. (i.e. below the LCST of the poly(N,N-diethylacrylamide)) has a higher particle size (about 180 nm) due to solvation with water of the polymer chains of the core that have once again become hydrophilic. Next, if the system is heated to 50° C., the same particle size is found as on leaving the reactor, which is proof that the crosslinking is effective. Furthermore, FIG. 2 shows that the phenomenon is entirely reversible, since the particle sizes at 15° C. and 50° C. measured alternately do not show any drift, and remain constant. Furthermore, the latex obtained is close to the monodispersity limit.

### Example 2

This example describes the copolymerization in aqueous dispersion of N,N-diethylacrylamide with N,N′-methylenebisacrylamide, the N,N′-methylenebisacrylamide being introduced into the reaction medium consecutively to the N,N-diethylacrylamide with 3 mol % of N,N′-methylenebisacrylamide.

1.61 g of poly(acrylic acid)-SG1 macroinitiator of molar mass 1880 g.mol⁻¹ and 12.82 g of NaOH are dissolved in a beaker in 72.15 g of deionized H₂O. 0.0205 g of SG₁ and 20.78 g of N,N-diethylacrylamide are mixed in another beaker. The two solutions are pooled as a solution 1. A solution 2 is prepared by mixing 5.60 g of NaOH, 32.05 g of deionized water, 0.0091 g of SG1, 9.23 g of N,N-diethylacrylamide and 1.09 g of N,N′-methylenebisacrylamide.

Solutions 1 and 2 are degassed by sparging with nitrogen, and are stirred at 300 rpm for 20 minutes.

Solution 1 is introduced into a 300 mL tank preheated to about 110° C., and is then stirred at 300 rpm under 3 bar. The temperature of the medium is maintained at 112° C. Examples of about 5 mL are taken at 30 and 60 minutes. Next, after 1 hour of reaction, solution 2 is introduced into the tank.

Samples of about 5 mL are taken every 30 minutes for a further 2 hours, and then every hour for 5 hours, and the reaction is finally stopped after 24 hours.

The size of the particles is determined before each sample has cooled, by adding a few tens of μL of the sample to 6 mL of deionized water at a temperature above 70° C. in a parallelepipedal polystyrene tank. The dilute sample is then analyzed by dynamic light scattering on a Malvern Nano ZS90 machine. The dilute sample is then characterized when cool, by lowering the nominal temperature of the Nano ZS90 to 15° C., and 50° C.-15° C.-50° C. temperature cycles are then performed.

The degree of conversion of the monomers into polymer is determined by gravimetry. About 1 g of each sample is placed in an aluminum crucible and then evaporated in a fume cupboard overnight, and then for a few hours in a desiccator heated at 85° C. under reduced pressure.

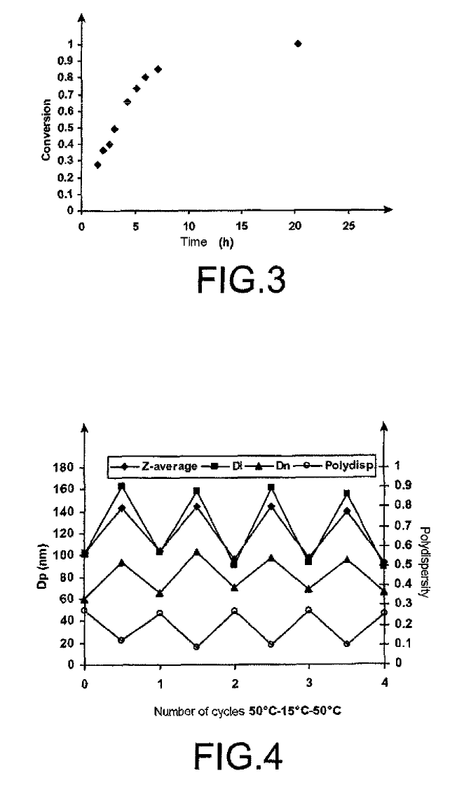

The two graphs given in FIGS. 3 and 4 show, respectively, the monitoring of the conversion of the monomers into polymer and the change in size of the microgel particles and of the polydispersity of the distribution in the course of the temperature cycles.

A 100% conversion of the monomers after about 20 hours is seen in FIG. 3.

FIG. 4 shows similar behavior for Example 2 to that of Example 1, except that, for the same proportion of crosslinking agent, lower particle diameters are obtained in this case.

### Example 3

This example describes the copolymerization in aqueous dispersion of N,N-diethylacrylamide with N,N′-methylenebisacrylamide, the N,N′-methylenebisacrylamide being introduced into the reaction medium consecutively to the N,N-diethylacrylamide with 5 mol % of N,N′-methylenebisacrylamide.

1.73 g of poly(acrylic acid)-SG1 macroinitiator of molar mass 2000 g.mol⁻¹ and 17.28 g of NaOH are dissolved in a beaker in 92.69 g of deionized H₂O. 0.0280 g of SG₁ and 27.76 g of N,N-diethylacrylamide are mixed in another beaker. The two solutions are pooled as a solution 1. A solution 2 is prepared by mixing 1.27 g of NaOH, 6.79 g of deionized water, 0.0021 g of SG1, 2.05 g of N,N-diethylacrylamide and 0.3644 g of N,N′-methylenebisacrylamide.

Solutions 1 and 2 are degassed by sparging with nitrogen, and are stirred at 300 rpm for 20 minutes.

Solution 1 is introduced into a 300 mL tank preheated to about 110° C., and is then stirred at 300 rpm under 3 bar. The temperature of the medium is maintained at 112° C. Examples of about 5 mL are taken at 30 and 60 minutes. Next, after 1 hour of reaction, solution 2 is introduced into the tank.

Samples of about 5 mL are taken every 30 minutes for a further 2 hours, and then every hour for 5 hours, and the reaction is finally stopped after 24 hours.

The size of the particles is determined before each sample has cooled, by adding a few tens of μL of the sample to 6 mL of deionized water at a temperature above 70° C. in a parallelepipedal polystyrene tank. The dilute sample is then analyzed by dynamic light scattering on a Malvern Nano ZS90 machine. The dilute sample is then characterized when cool, by lowering the nominal temperature of the Nano ZS90 to 15° C., and 50° C.-15° C.-50° C. temperature cycles are then performed.

The degree of conversion of the monomers into polymer is determined by gravimetry. About 1 g of each sample is placed in an aluminum crucible and then evaporated in a fume cupboard overnight, and then for a few hours in a desiccator heated at 85° C. under reduced pressure.

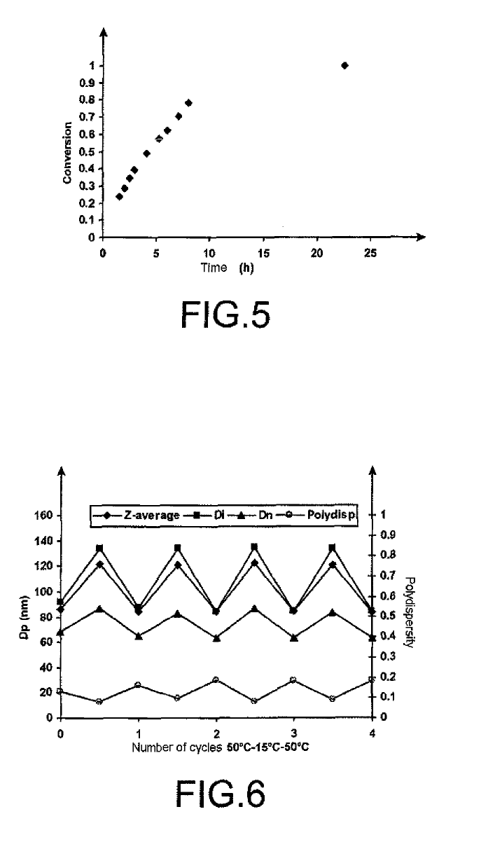

The two graphs given in FIGS. 5 and 6 show, respectively, the monitoring of the conversion of the monomers into polymer and the change in size of the microgel particles in the course of the temperature cycles.

The monomer conversion reached after more than 20 hours of reaction is 100%, as shown in FIG. 5. Once again, heat-sensitive microgel particles are obtained and show proof of the reversible nature of the temperature sensitivity and thus effective crosslinking. The diameters obtained, as shown in FIG. 6, are lower in this case than in Example 2, and the hot polydispersity decreases.

1. A process for preparing microgel particles in aqueous medium, comprising the following steps:
a) preparing a living macroinitiator obtained by polymerization of one or more monomers in the presence of a control agent corresponding to one of the following formulae: 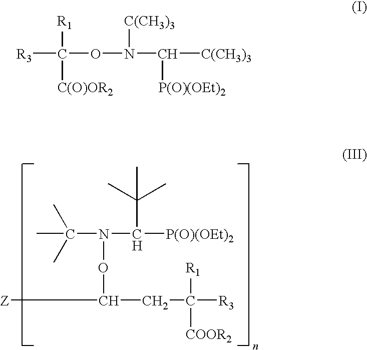
in which:
R₁ and R₃, which may be identical or different, represent a linear or branched alkyl group having a number of carbon atoms ranging from 1 to 3;
R₂ represents a hydrogen atom, a linear or branched alkyl group having a number of carbon atoms ranging from 1 to 8, a phenyl group, an alkali metal or an ammonium ion;
Z represents an aryl group or a group of formula Z₁—[X—C(O)]ₙ, in which Z₁ represents a polyfunctional structure, X is an oxygen atom, a nitrogen atom bearing a carbon-based group or a hydrogen atom, or a sulfur atom; and
n is an integer greater than or equal to 2;
b) adding to the reaction medium obtained after step a) at least one vinyl monomer that is different than that of step a);
c) adding to the reaction medium at least one crosslinking comonomer, the crosslinking comonomer being different than the monomers of steps a) and b), this addition step being performed simultaneously or consecutively relative to the addition step b),
wherein the constituent monomer(s) of the living macroinitiator of step a) and/or the vinyl monomers of step b) and/or the crosslinking comonomer(s) of step c) comprise at least one function chosen from —CO₂H, —SO₃H, ammonium, ethylene oxide, amino and amide, said function possibly existing in the form of salts.

2. The process as claimed in claim 1, in which the constituent monomers of the living macroinitiator of step a) comprise at least one function chosen from —CO₂H, —SO₃H, ammonium, ethylene oxide, amino and amide, said function possibly existing in the form of salts.

3. The process as claimed in claim 1, in which the constituent monomers of the living macroinitiator of step a) are chosen from the group consisting of (meth)acrylic monomers, dialkylaminoalkyl(meth)acrylate monomers, trialkylammoniumalkyl(meth)acrylate halides, (alkoxy)polyalkylene glycol(meth)acrylate monomers, (meth)acrylamide monomers optionally comprising a sulfonate group, and styrene monomers comprising a sulfonate group.

4. The process as claimed in claim 1, in which the constituent monomers of the living macroinitiator of step a) are acrylic acid or methacrylic acid.

5. The process as claimed in claim 1, in which the control agent corresponds to the following formula:

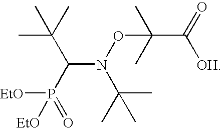

6. The process as claimed in claim 1, in which the control agent corresponds to the following formula:

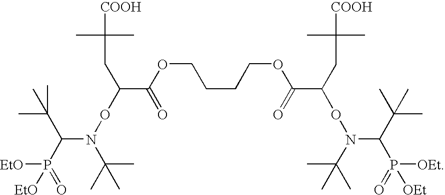

7. The process as claimed in claim 1, in which the vinyl monomers introduced in step b) are chosen from vinylaromatic monomers, acrylic monomers such as alkyl or aryl acrylates, methacrylic monomers such as alkyl or aryl methacrylates, acrylamide monomers and methacrylamide monomers.

8. The process as claimed in claim 1, in which the vinyl monomers introduced in step b) are monoalkylacrylamide or dialkylacrylamide monomers.

9. The process as claimed in claim 8, in which the dialkylacrylamide monomer is N,N-dimethylacrylamide, N,N-diethylacrylamide or N,N-diisopropylacrylamide.

10. The process as claimed in claim 8, in which the monoalkylacrylamide monomer is N-methylacrylamide, N-ethylacrylamide or N-isopropylacrylamide.

11. The process as claimed in claim 1, in which the vinyl monomers are introduced into the reaction medium in a proportion of at least 10% by weight, based on the total weight of monomers added.

12. The process as claimed in claim 1, in which the crosslinking monomers are chosen from divinylbenzenes, trivinylbenzenes, allyl(meth)acrylates, diallyl maleate polyol(meth)acrylates, alkylene glycol di(meth)acrylates containing from 2 to 10 carbon atoms in the carbon chain, and N,N′-alkylenebisacryl amides.

13. The process as claimed in claim 12, in which the crosslinking comonomer is N,N′-methylenebisacrylamide.

14. The process as claimed in claim 1, in which the crosslinking comonomer is introduced into the reaction medium in a content ranging from 1% to 12% by weight relative to the weight of vinyl monomer(s) introduced in step b).

15. The process as claimed in claim 1, in which the addition step c) is performed consecutively to the addition step b).

16. The process as claimed in claim 1, further comprising a step of adding to the reaction medium components intended to be encapsulated by the particles.

17. Microgel particles that may be obtained via a process as defined according to claim 1.

18. The microgel particles as defined in claim 17, wherein said microgel particle is an encapsulation material.

19. The use of microgel particles as defined in claim 17, wherein said microgel particle is a thickener.

20. The microgel particles of claim 17, comprising a pharmaceutical, biomedical, agrochemical, human or animal nutrition, cosmetic, paint, or surface coating composition.
